(19) United States
(12) Patent Application Publication
(10) Pub. No.: US 2002/0170064 A1
(43) Pub. Date: Nov. 14, 2002

(54) Portable, wireless monitoring and control station for use in connection with a multi-media surveillance system having enhanced notification functions

(76) Inventors: David A. Monroe, San Antonio, TX (US); Raymond Metzger, San Antonio, TX (US)

Correspondence Address: BRACEWELL & PATTERSON, P.O. Box 61389, Houston, TX, 77208-1389, US

(21) Appl. No.: 09/854,033

(22) Filed: May 11, 2001

(51) Int. Cl. H04N 7/173

(52) U.S. Cl. 725/105

(57) ABSTRACT

An enhanced, digitized security system provides wireless, portable monitoring and control capability for a system having a plurality of cameras in a network and connected to a suitable hub. The portable module is also in wireless communication with a server. The permits remote installation and aiming of the cameras, remote viewing, remote database access and remote capture of information for transmission to the database server such as images, video, and other security data for archiving and management. A transmitter is associated with the hub for transmitting the signals via a wireless network to a portable, handheld receiving station, wherein any of the cameras on the network may be accessed and displayed on the portable station display screen. The portable station also includes a transmitter for transmitting control information back to the hub for controlling each of the cameras, permitting full control of the cameras for adjusting contrast, hue, brightness, pan, tilt and zoom, and focus. The multi-camera system is also connected to a server via the hub and the portable station can communicate with the server via the wireless hub to access stored data for retrieval and replay. The system also supports ancillary features such as remote access to student or employee records anywhere the portable unit is used, ID verification by use of a magnetic reader or bar code reader provided on the portable unit and other identification systems such as, by way of example, biometric sampling. Access control devices may be controlled at the portable module, permitting controlled access to various facilities as the user moves about with the portable station. Full communication capability is provided, with communication links to e-mail, telephone and other communication networks and systems. The system is enhanced to selectively notify designated personnel either at the fixed stations or at the portable, wireless stations, upon detection of a motion event, or any other event detectable by the system.

### BACKGROUND OF THE INVENTION

1. Field of the Invention

The subject invention is related to security and surveillance systems and is specifically directed to a wireless, portable control and display module for a digital wireless surveillance system.

Discussion of the Prior Art

It is known to provide a surveillance/security system containing a plurality of video cameras. The earliest of these include closed circuit television systems (CCTV) wherein a plurality of cameras are wired through a multiplexer to a plurality of analog video recorders and to live feed display monitors.

Security of public facilities such as schools, banks, airports, arenas and the like has been a topic of increasing concern in recent years. Over the past few years, a number of violent incidents including bombings, shootings, arson, and hostage situations have occurred. In addition, agencies responsible for public security in these facilities must cope with more commonplace crimes, such as drug dealing, vandalism, theft and the like.

Such facilities frequently employ monitoring and surveillance systems to enhance security. This has been common practice for a number of years. Such systems generally have a centralized monitoring console, usually attended by a guard or dispatcher. A variety of sensors, cameras and the like are located throughout the facility. These detectors and sensors, or devices, are utilized to collect information at remote locations and initiate a local alarm, store the information for later retrieval or forward the information to a remote location for storage and/or near real time review and/or later search and retrieval. Almost all of such devices can be used in some form of managed network where one or more devices may be used in combination to provide a surveillance scheme over an area to be monitored. In prior art systems, the signal generated by each type of device was used locally, or if part of a network, was sent over a dedicated network to a remote collection point for that type of device. For example, prior art alarm systems can be monitored locally or remotely by a monitor console. Video surveillance systems are typically monitored locally or recorded by local video tape recorders.

These prior-art monitoring devices often use technologies that not ‘intelligent’ in the modem sense; they merely provide an ‘ON/OFF’ indication to the centralized monitoring system. The appliances also are not ‘networked’ in the modem sense; they are generally hard-wired to the centralized monitoring system via a ‘current loop’ or similar arrangement, and do not provide situational data other than their ON/OFF status.

Video surveillance systems in common use today are particularly dated—they are generally of low quality, using analog signals conveyed over coaxial or, occasionally, twisted-pair cabling to the centralized local monitoring facility. Such visual information is generally archived on magnetic tape using analog video recorders. Further, such systems generally do not have the ability to ‘share’ the captured video, and such video is generally viewable only on the system's control console.

Prior art systems have typically employed analog cameras, using composite video at frame rates up to the standard 30 frames/second. Many such systems have been monochrome systems, which are less costly and provide marginally better resolution with slightly greater sensitivity under poor lighting conditions than current analog color systems. Traditional video cameras have used CCD or CMOS area sensors to capture the desired image. The resolution of such cameras is generally limited to the standard CCTV 300-350 lines of resolution, and the standard 480 active scan lines.

Such cameras are deployed around the area to be observed, and are connected to a centralized monitoring/recording system via coaxial cable or, less often, twisted-pair (UTP) wiring with special analog modems. The signals conveyed over such wiring are almost universally analog, composite video. Baseband video signals are generally employed, although some such systems modulate the video signals on to an RF carrier, using either AM or FM techniques. In each case, the video is subject to degradation due to the usual causes—crosstalk in the wiring plant, AC ground noise, interfering carriers, and so on.

More recently, security cameras have employed video compression technology, enabling the individual cameras to be connected to the centralized system via telephone circuits. Due to the bandwidth constraints imposed by the public-switched telephone system, such systems are typically limited to low-resolution images, or low frame rates, or both. Other more modem cameras have been designed for “web cam” use on the Interent. These cameras use digital techniques for transmission, however their use for security surveillance is limited by low resolution and by slower refresh rates. These cameras are also designed for used by direct connection to PC's, such as by Printer, USB or Firewire Ports. Thus the installation cost and effectivity is limited with the unwieldy restriction of having to have a PC at each camera.

Prior-art surveillance systems are oriented towards delivering a captured video signal to a centralized monitoring facility or console. In the case of analog composite video signals, these signals were transported as analog signals over coaxial cable or twisted-pair wiring, to the monitoring facility. In other systems, the video signals were compressed down to low bit rates, suitable for transmission over the public-switched telephone network or the Interent. Each of these prior-art systems suffers functional disadvantages. The composite video/coaxial cable approach provides full-motion video but can only convey it to a local monitoring facility. The low-bit rate approach can deliver the video signal to a remote monitoring facility, but only with severely degraded resolution and frame rate. Neither approach has been designed to provide access to any available video source from several monitoring stations.

Another commonplace example is the still-image compression commonly used in digital cameras. These compression techniques may require several seconds to compress a captured image, but once done the image has been reduced to a manageably small size, suitable for storage on inexpensive digital media (e.g., floppy disk) or for convenient transmission over an inexpensive network connection (e.g. via the internet over a 28.8 kbit/sec modem).

Prior-art surveillance systems have been oriented towards centralized monitoring of the various cameras. While useful, this approach lacks the functional flexibility possible with more modem networking technologies.

Video monitoring and surveillance of locations or areas for security, safety monitoring, asset protection, process control, and other such applications by use of closed circuit television and similar systems have been in widespread use for many years. The cost of these systems has come down significantly in recent years as the camera and monitor components have steadily dropped in cost while increasing in quality. As a result, these systems have proliferated in their application and are proving extremely useful for both commercial and residential applications.

These “closed circuit television” systems typically consist of a monochrome or color television camera, a coaxial cable, and a corresponding monochrome or color video monitor, optional VCR recording devices, and power sources for the cameras and monitors. The interconnection of the camera and monitor is typically accomplished by the use of coaxial cable, which is capable of carrying the 2 to 10 megahertz bandwidths of baseband closed circuit television systems. There are several limitations to coaxial cable supported systems. First, the cable attenuates by the signal in proportion to the distance traveled. Long distance video transmission on coaxial cable requires expensive transmission techniques. Second, both the cable, per se, and the installation is expensive. Both of these limitations limit practical use of coaxial closed circuit systems to installations requiring less than a few thousand feet of cable. Third, when the cable cannot be concealed is not only unsightly, but is also subject to tampering and vandalism.

Other hardwired systems have been used, such as fiber optic cable and the like, but have not been widely accepted primarily due to the higher costs associated with such systems over coaxial cable. Coaxial cable, with all of its limitations, remains the system of choice to the present day. Also available are techniques using less expensive and common twisted pair cable such as that commonly used for distribution of audio signals such as in telephone or office intercom applications. This cable is often referred to as UTP (twisted pair) or STP (shielded twisted pair) cable. Both analog and digital configurations are available. Both analog and digital techniques have been implemented. This general style of twisted pair cable but in a more precise format is also widely used in Local Area Networks, or LAN's, such as the 10Base-T Ethernet system, 100 Base-T, 1000 Base-T and later systems. Newer types of twisted pair cable have been developed that have lower capacitance and more consistent impedance than the early telephone wire. These newer types of cable, such as “Category 5” wire, are better suited for higher bandwidth signal transmission and are acceptable for closed circuit video applications with suitable special digitaly interfaces. By way of example, typical audio voice signals are approximately 3 kilohertz in bandwidth, whereas typical video telecision signals are 3 megahertz in bandwidth or more. Even with the increased bandwidth capability of this twisted pair cable, the video signals at base band (uncompressed) can typically be distributed directly over twisted pair cable only a few hundred feet. In order to distribute video over greater distances, video modems (modulator/demodulators) are inserted between the camera and the twisted pair wiring and again between the twisted pair wiring and the monitor. Twisted pair cable is lower in cost than coaxial cable and is easier to install. For the longest distances for distribution of video, the video signals are digitally compressed for transmission and decompressed at the receiving end.

Wireless systems utilizing RF energy are also available. Such systems usually consist of a low power UHF transmitter and antenna system compatible with standard television monitors or receivers tuned to unused UHF channels. The FCC allows use of this type of system without a license for very low power levels in the range of tens of milliwatts. This type of system provides an economical link but does not provide transmission over significant distances due to the power constraints placed on the system. It is also highly suscepitable to interference due to the low power levels and share frequency assignments. The advantage of this system over hardwired systems is primarily the ease of installation. However, the cost is usually much higher per unit, the number of channels is limited and system performance can be greatly affected by building geometry or nearby electrical interference. Further, the video is not as secure as hardwired systems. The video may be picked up by anyone having access to the channel while in range of the transmitter and is thus, easily detected and/or jammed.

Because of the inherent limitations in the various closed circuit television systems now available, other media have been employed to perform security monitoring over wider areas. This is done with the use of CODECs (compressors/decompressors) used to reduce the bandwidth. Examples include sending compressed video over standard voice bandwidth telephone circuits, more sophisticated digital telephonic circuits such as frame relay or ISDN circuits and the like. While commonly available and relatively low in cost, each of these systems is of narrow bandwidth and incapable of carrying “raw” video data such as that produced by a full motion video camera, using rudimentary compression schemes to reduce the amount of data transmitted. As previously discussed, full motion video is typically 2 to 10 megahertz in bandwidth while typical low cost voice data circuits are 3 kilohertz in bandwidth.

There are known techniques for facilitating “full motion” video over common telecommunication circuits. The video teleconferencing (VTC) standards currently in use are: Narrow Band VTC (H.320); Low Bitrate (H.324); ISO-Ethernet (H.322); Ethernet VTC (H.323); ATM VTC (H.321); High Resolution ATM VTC (H.310). Each of these standards has certain advantages and disadvantages depending upon the volume of data, required resolution and costs targets for the system. These are commonly used for video teleconferencing and are being performed at typical rates of 128K, 256K, 384K or 1.544M bit for industrial/commercial use. Internet teleconferencing traditionally is at much lower rates and at a correspondingly lower quality. Internet VTC may be accomplished at 33.6 KBPS over dial-up modems, for example. Video teleconferencing is based on video compression, such as the techniques set forth by CCITT/ISO standards, Internet standards, and Proprietary standards or by MPEG standards. Other, sometimes proprietary, schemes using motion wavelet or motion JPEG compression techniques and the like are also in existence. There are a number of video teleconferencing and video telephone products available for transmitting “full motion” (near real-time) video over these circuits such as, by way of example, systems available from AT&T and Panasonic. While such devices are useful for their intended purpose, they typically are limited in the amount of data, which may be accumulated and/or transmitted because they do not rely on or have limited compression. There are also devices that transmit “live” or in near real-time over the Internet, such as QuickCam2 from Connectix, CU-See-Me and Intel products utilizing the parallel printer port, USB port, Firewire port, ISA, PCI card, or PCMCIA card on a laptop computer. Many of these are personal communications systems do not have the resolution, the refresh rate required or the security required to provide for good surveillance systems. NetMeeting from Microsoft and Proshare software packages from Intel also provide low quality personal image distribution over the Internet.

All of the current low cost network products have the ability to transmit motion or “live” video. However, such products are limited or difficult, if not impossible, to use for security applications because the resolution and refresh rate (frame rate) of the compressed motion video is necessarily low because of limited resolution of the original sample and the applications of significant levels of video compression to allow use of the low bandwidth circuits. The low resolution of these images will not allow positive identification of persons at any suitable distance from the camera for example. The low resolution would not allow the reading of an automobile tag in another example.

As these devices, particularly digital video cameras and encoders, come in more widespread use within a system, the amount of bandwidth required to transmit continuous, “live” images from an array of cameras is staggering. This is even a greater problem when retrofitting current facilities where it is desired to use current wiring or to incorporate wireless networking techniques. Even where the conduits are of sufficient capacity to handle the data load, storage and retrieval becomes an enormous task. It is, therefore, desirable to provide a system capable of maximizing the information available via a security system while at the same time minimizing transmission and storage requirements.

In many security applications it is desirable to monitor an area or a situation with high resolution from a monitor located many miles from the area to be surveyed. As stated, none of the prior art systems readily available accommodates this. Wide band common carriers such as are used in the broadcast of high quality television signals could be used, but the cost of these long distance microwave, fiber or satellite circuits is prohibitive.

None of the prior art systems permit structured and controlled notification based on the identification of events as they occur. Even those that do permit some limited notification, for example, alarm systems sending a telephone signal to a monitoring station, do not provide detailed event information. Such systems are more global in configuration, simply sending a notification that an event has occurred at a monitored facility.

More recently, and as described in my copending applications, entitled Method and Apparatus for Collecting, Sending, Archiving and Retrieving Motion Video and Still Images and Notification of Detected Events, filed on even date herewith; Digital Security Multimedia Sensor, Ser. No. 09/593,361, filed on Jun. 14, 2000, Dual Mode Camera, Ser. No. 09/593,901, filed on Jun. 14, 2001, Method and Apparatus for Distributing Digitized Streaming Video Over a Network, Ser. No. 09/716,141, filed on Nov. 17, 2000, Multiple Video Display Configurations and Bandwidth Conservation Scheme for Transmitting Video Over a Network, Ser. No. 09/715,783, filed on Nov. 17, 2000, Multiple Video Display Configurations and Remote Control of Multiple Video Signals Transmitted to a Monitoring Station Over a Network, Ser. No. 09/725,368, filed on Nov. 29, 2000, the analog signal from the various cameras has been replaced by a digital data signal either created at the camera in MPEG, SIF, QSIF or JPEG, or transmitted to a remote server location as an analog signal there converted to the desired digital format. Each of the cameras captures a signal that is either transmitted and then compressed or compressed and then transmitted to a network. Video or images thus networked may be selectively viewed on an operator's console, or may be received by a networked server for storage, analysis, and subsequent retrieval.

In my above described application, each camera additionally performs motion detection within its captured scene, by analyzing differences between periodically sampled scenes. Upon detection of a motion event, the camera may take a variety of actions, including

Storing a still-image of the scene containing motion

Commanding a remote server to store the image

Storing the scene captured immediately prior to the motion event

Commanding a remote viewing station to display live video from the camera

Commanding the server to store live video from the camera.

### SUMMARY OF THE INVENTION

The subject invention is an enhanced, digitized security system providing wireless, portable monitoring and control capability. The system includes a plurality of cameras in a network and connected to a suitable hub. The cameras may be hardwired to the hub, or may themselves be connected to the hub via a wireless network. A transmitter is associated with the hub for transmitting the signals via a wireless network to a portable, handheld receiving station, wherein any of the cameras on the network may be accessed and displayed on the portable station display screen. The portable station also includes a transmitter for transmitting control information back to the hub for controlling each of the cameras, permitting full control of the cameras for adjusting contrast, hue, brightness, pan, tilt and zoom, and focus.

The multi-camera system is also connected to a server via the hub and the portable station can communicate with the server via the wireless hub to access stored data for retrieval and replay. As described in my aforementioned applications, incorporated by reference herein, the server includes the means and methods for providing a detailed map of the covered areas, including the location of cameras and other appliances and alarms. The mapping function is available at the portable station via the wireless transmission and reception system, with full control functionality at the portable station, including access to alarm location and condition, selection of and control of cameras, access to archives and history data and other features available in the wired system and fixed monitor and display stations of my previous inventions.

The system also supports ancillary features such as remote access to student or employee records anywhere the portable unit is used, ID verification by use of a magnetic reader or bar code reader provided on the portable unit and other identification systems such as, by way of example, biometric sampling.

In addition, access control devices may be controlled at the portable module, permitting controlled access to various facilities as the user moves about with the portable station. Other appliances and components may be likewise controlled, as an example, security or facility lighting and the like.

Full communication capability is also provided, with communication links to e-mail, telephone and other communication networks and systems.

The portable unit may also include a camera by which both video and still images may be capture for transmission to the hub via the wireless link.

In the present invention, the system is enhanced to selectively notify designated personnel either at the fixed stations or at the portable, wireless stations, upon detection of a motion event, or any other event detectable by the system.

In the preferred embodiment, the cameras generate compressed digital video streams for transmission over a network. To enhance the utility of the network, the cameras transmit their respective video streams using an IP multicast protocol, which allows multiple simultaneous viewers of any given video stream. Alternatively, a point-to-point protocol may be used for simplicity. This imposes a bandwidth penalty when multiple viewers receive the same video, since identical video packets are replicated over the network. In either case, any given network may frequently be conveying several dozen such video streams, requiring tens of megabits/second of network bandwidth.

Wireless networks typically have limited bandwidth. As mentioned, a wired network may carry several dozen streams of 1 Megabit/second video. Common wireless networks, however, are typically far more bandwidth-constrained. Typical IEEE 802.11 wireless LAN's support a maximum bandwidth of 11 MB/s. Moreover, in wireless networks it is common practice to ‘trade-off’ network speed in exchange for improved bit-error-rate. In other words, greater distances may be obtained by sacrificing network speed. This makes bandwidth on a wireless network even more precious than on a wired network.

If such a wireless LAN, of limited bandwidth, were connected to a wired LAN, the wireless network would become unusable due to the enormous amount of traffic present on the wired network. In the present invention, this problem is effectively overcome through the use of a protocol translator located on the network. A client, located on a wireless network, sends a request to the protocol translator, identifying the desired video stream. The protocol translator then connects to the desired multicast stream on the wired network, and forwards it to the wireless client using an ordinary TCP/IP protocol. As a result, the wireless network need not transport all multicast traffic that is present on the wired network. The wireless network need carry only those video streams that have been specifically requested by the wireless clients. The protocol translator is adapted for converting the multicast input signals into a unicast output signal by stripping the multicast header information from the data and replacing it with a unicast header using standard IP multicast and IP unicast protocols.

In one enhancement of the invention, the wireless signal strength is monitored by monitoring and displaying the condition of the packet buffer for receiving the data from the wireless network interface. The level of the packet buffer, in real time, indicates the strength of signal.

It is, therefore, an object and feature of the subject invention to provide a full function, portable wireless monitoring and display module for use in combination with a comprehensive, multimedia surveillance system.

It is also an object and feature of the subject invention to provide wireless access to the system server via the wireless network interface.

It is a further object and feature to provide full notification and management functionality at the wireless portable module.

It is another object and feature of the subject invention to provide access to the mapping capability for determining both the location of the camera, sensors and appliances being accessed and the location of the wireless, portable module.

It is an additional object and feature of the subject invention to provide access to and control of archived records at the wireless, portable module.

It is a further object and feature of the subject invention to provide access to employee or student records for identification verification.

It is another object and feature of the subject invention to provide full communication capability via the wireless, portable module.

It is also an object and feature of the subject invention to provide the creation and transmission of video and still images at the wireless, portable module for transmission to the system via the wireless network interface.

It is an additional object and feature of the subject invention to provide visible indication of signal quality (can discuss “strength” which is one way, and “buffer status” which is another way, or a hybred) of the received signals at the wireless, portable module.

It is an additional object of the invention to provide for remote setup of mounted cameras by controlling zoom, pan, tilt, focus, hue, brightness and the like from the remote module during initial setup.

Other objects and features of the invention will be readily apparent from the accompanying drawings and detailed description of the preferred embodiment.

### BRIEF DESCRIPTION OF THE DRAWINGS

FIG. 1 illustrates a system diagram for a wireless system.

FIG. 2 illustrates a wireless system having a multicast/unicast routing component.

FIG. 3 is an expansion of the diagram of FIG. 18 to better illustrate the multicast/unicast features.

FIG. 4 illustrates the use of the packet buffer as a signal strength generator.

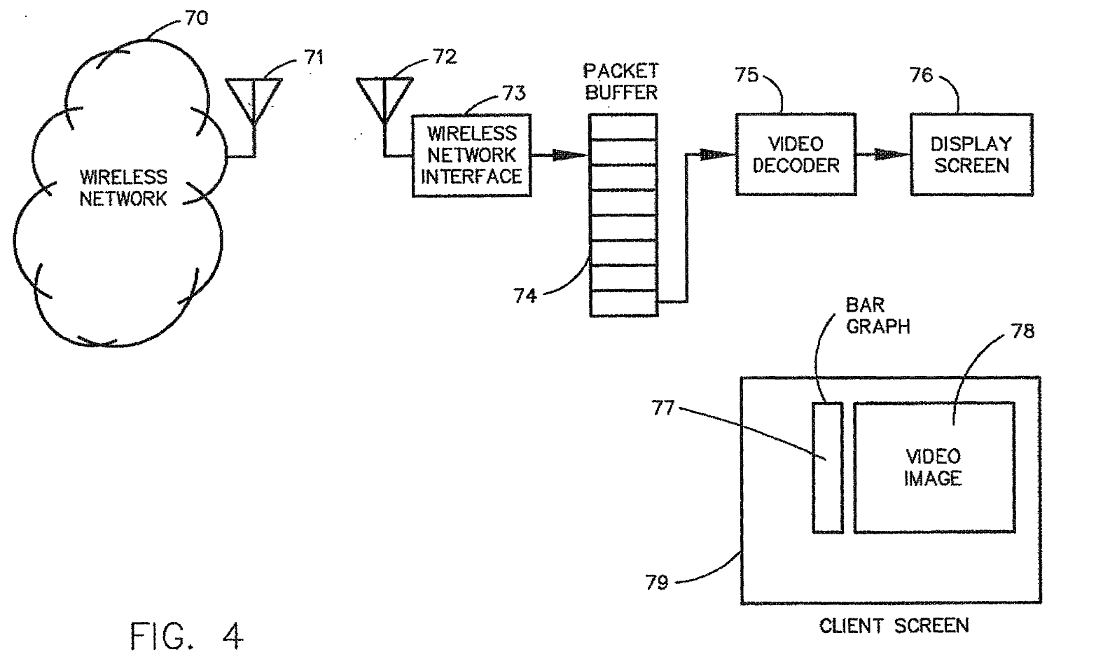

### DETAILED DESCRIPTION OF THE PREFERRED EMBODIMENTS

The subject invention is an enhanced, digitized security system providing wireless, portable monitoring and control capability. The system includes a plurality of cameras in a network and connected to a suitable hub. The cameras may be hardwired to the hub, or may themselves be connected to the hub via a wireless network. A transmitter is associated with the hub for transmitting the signals via a wireless network to a portable, handheld receiving station or module, wherein any of the cameras on the network may be accessed and displayed on the portable station display screen. The portable station also includes a transmitter for transmitting control information back to the hub for controlling each of the cameras, permitting full control of the cameras for adjusting contrast, hue, brightness, pan, tilt and zoom, and focus. This facilitates installation by permitting the camera to be installed in a location and then later aimed and focused from the remote control module rather than physically adjusting the camera at the point of installation.

This transmitter” can be an industry standard wireless LAN such as from Aeronet (now Cisco) with chips from Intersil and others, using IEEE 802.11B or other suitable standard protocols.

The multi-camera system is also connected to a server via the hub and the portable station can communicate with the server via the wireless hub to access stored data for retrieval and replay. As described in my aforementioned applications, incorporated by reference herein, the server includes the means and methods for providing a detailed map of the covered areas, including the location of cameras and other appliances and alarms, as well as notification methodology.

The system also supports ancillary features such as remote access to student or employee records anywhere the portable unit is used, ID verification by use of a magnetic reader or bar code reader provided on the portable unit and other identification systems such as, by way of example, biometric sampling.

In addition, access control devices may be controlled by authorized users, permitting controlled access to various facilities as the user moves about with the portable station. Also see access control system status, areas that are alarmed—perhaps indicated on them map, and access logs showing previous accesses.

Full communication capability is also provided, with communication links to e-mail, telephone and other communication networks. Specifically, the module is capable of sending and receiving any data from the remote location to the server and can include text, image, video and voice messages.

The portable unit may also include a camera by which both video and still imagemay be captured for transmission to the hub via the wireless link and allows adding stills or motion data to the server's archive database for future retrieval, or provides the capability for other monitor stations to receive the video and stills on a real time or near real time basis.

The mapping function is available at the portable station via the wireless transmission and reception system, with full control functionality at the portable station, including access to alarm location and condition, selection of and control of cameras, access to archives and history data and other features available in the wired system and fixed monitor and display stations of my previous inventions.

As previously described herein, the cameras generate compressed digital video streams for transmission over a network. To enhance the utility of the network, the cameras transmit their respective video streams using an IP Multicast Protocol, which allows multiple simultaneous viewers of any given video stream. Alternatively, a point-to-point protocol may be used for simplicity. This imposes a bandwidth penalty when multiple viewers receive the same video, since identical video packets are replicated over the network. In either case, any given network may frequently be conveying several dozen such video streams, requiring tens of megabits/second of network bandwidth.

Wireless networks typically have limited bandwidth. As mentioned, a wired network may carry several dozen streams of 1 Megabit/second video. Common wireless networks, however, are typically far more bandwidth-constrained. Typical IEEE 802.11 wireless LAN's support a maximum bandwidth of 11 MB/s. Moreover, in wireless networks it is common practice to ‘trade-off’ network speed in exchange for improved bit-error-rate. In other words, greater distances may be obtained by sacrificing network speed. This makes bandwidth on a wireless network even more precious than on a wired network.

If such a wireless LAN, of limited bandwidth, were connected to a wired LAN, the wireless network would become unusable due to the enormous amount of traffic present on the wired network. In the present invention, this problem is effectively overcome through the use of a protocol translator located on the network. A client, located on a wireless network, sends a request to the protocol translator, identifying the desired video stream. The protocol translator then connects to the desired multicast stream on the wired network, and forwards it to the wireless client using an ordinary TCP/IP protocol. As a result, the wireless network need not transport all multicast traffic that is present on the wired network. The wireless network need carry only those video streams that have been specifically requested by the wireless clients.

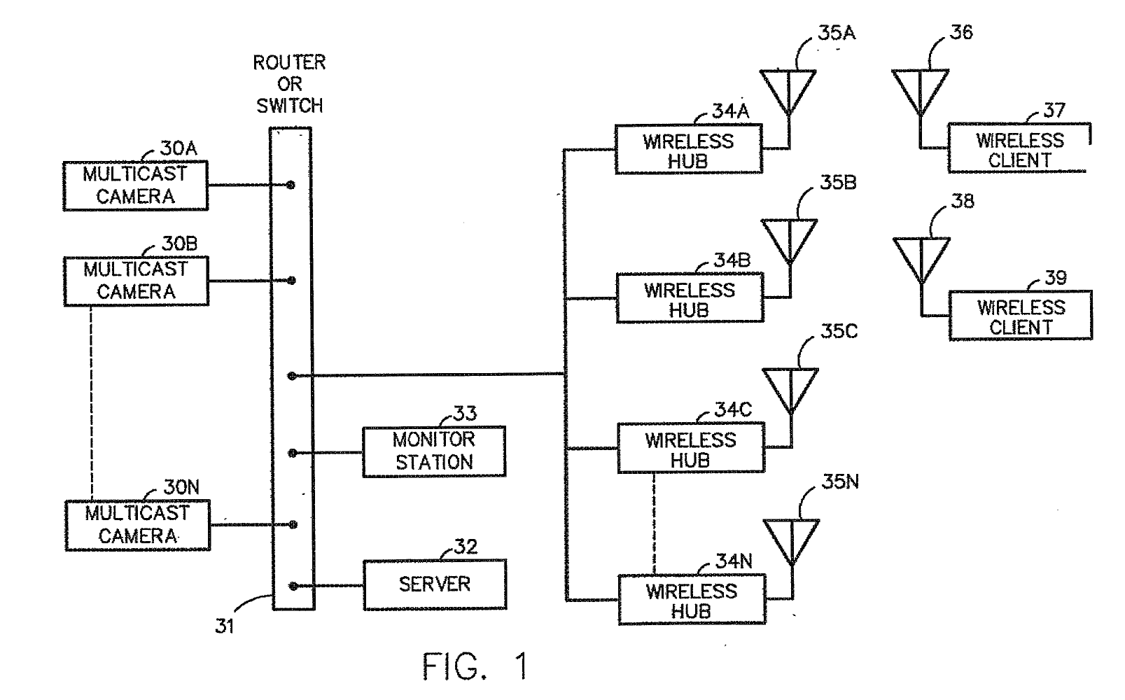

FIG. 1 illustrates a representative such network. A plurality of compressed digital multicast cameras 30A through 30N are connected to a wired network, typically through a network switch or router 31. One or more monitor stations 33 may be connected by network wiring to the network. A server 32 is connected to the network, and is used for image archival, event or alarm processing, or serving appropriate HTML pages to clients viewing cameras or browsing the image database. In addition, a wireless network is connected to the network router or switch 31. The wireless network consists of a number of wireless hubs 34A through 34N, disposed at various sites around the facility. The wireless hubs 34A through 34N may be interconnected via a multi-drop topology such as 10Base-T or equivalent, or may use a series of network hubs (not shown). One or more wireless clients 37 or 39 are free to roam the facility, connecting to the wired network via antennae 35A through 35N, 36 and 38. These wireless clients may use the network to receive selected camera video streams or view selected images from the image storage database.

The wired network may, at any given time, be transporting tens of megabits/second of streaming video data. However, the wireless network collectively may be limited to an aggregate of 1 to 10 megabits/second. If directly connected to the wired network, the wireless hubs would be swamped with excessive traffic, and would be effectively unable to pass the desired data to the wireless clients.

The wireless hubs can be easily isolated from the enormous volume of streaming multicast video traffic on the wired network. This can be done by configuring the network switch or router 31 to block all multicast traffic. Unfortunately, this also prevents the wireless client from receiving any multicast video traffic.

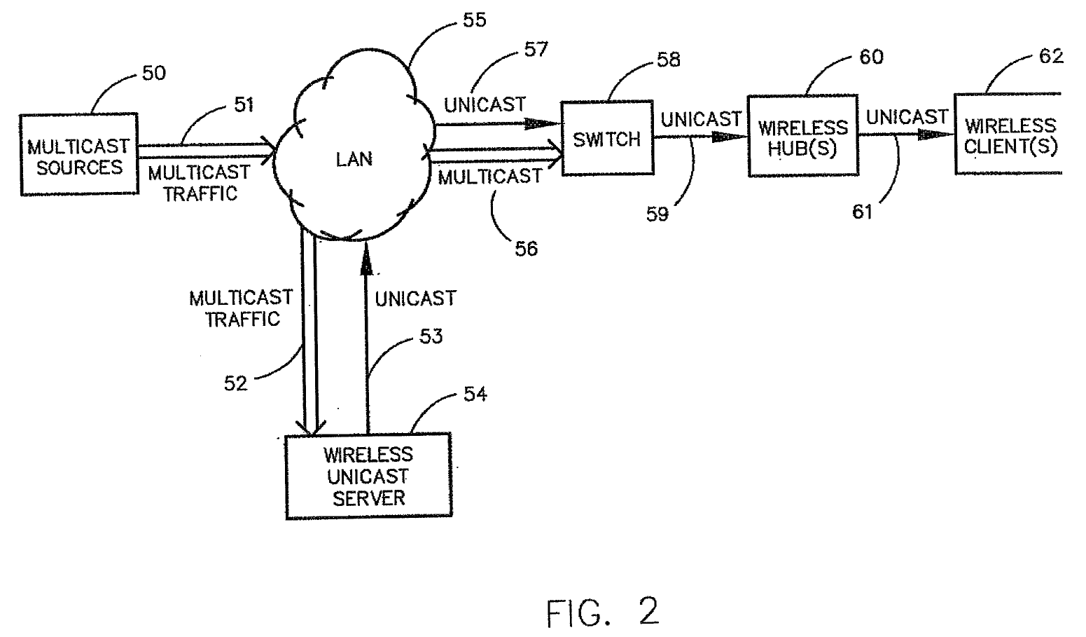

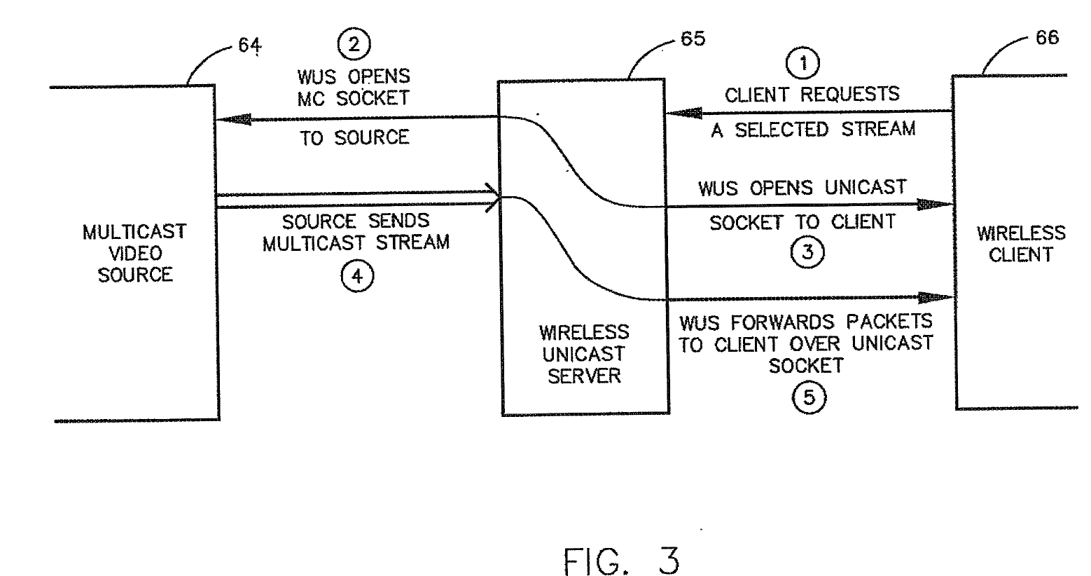

FIGS. 2 and 3 illustrate a solution. In FIG. 2, the various multicast cameras 50 produce a volume of multicast traffic 51. This multicast traffic is conveyed via the wired network 55 to the network switch or router 58, and to a Wireless Unicast Server (WUS) 54. The WUS receives the network multicast traffic 52, selects one desired multicast stream as defined by client 62, and forwards that selected video stream to the client as a unicast stream 53, 57, 59, and 61. Since the network switch or router 58 has been configured to block forwarding of any multicast traffic, the wireless hub(s) 60 need convey only the selected unicast traffic 59. Since each such unicast video stream is typically 1 megabit/second or less, the wireless network is easily capable of delivering the selected video streams to the client(s) 62.

FIG. 3 illustrates the client-server transactions involved. A wireless client identifies a desired video stream, and sends a request to the Wireless Unicast Server in step 1. The WUS attempts to open a socket to the selected multicast source in step 2. If successful, the WUS opens a Unicast socket to the client in step 3. The WUS then begins receiving multicast data from the multicast source in step 5. The WUS forwards this data to the Wireless Client in step 5. The network switch or router forwards the unicast traffic but blocks the multicast traffic. The client is thus able to view the selected multicast video stream, and the wireless hubs are not overloaded with the multicast traffic present on the wired network.

In wireless networks, coverage of any given facility is not complete. Wireless networks, operating over low-power microwave channels, have limited range. The systems also exhibit ‘dead spots’ in their coverage area, areas where the desired RF signal is not present due to the effects of multipath fading or due to interference from other RF devices. It is thus very helpful, to the wireless user, to have some sort of visual indication of the current signal quality.

In the present invention, this is accomplished with a bar graph display, shown on the client's screen, showing the current receiver buffer fullness. FIG. 3 illustrates the concept. The overall wireless network 70 communicates with the client's Wireless Network Interface 73 via antennas 71 and 72. As incoming packets are received, they are placed in the client's receive buffer 74, which is organized as a First-in, First-out (FIFO) buffer. Packets are removed from the buffer 74 in sequence according to timestamps generated by the originating video source. These packets are forwarded to the video decoder 75 and display screen 76 for viewing.

Since the video stream is continuous, the receiver normally removes packets from the buffer at a rate equal to that of the transmitter. When the client begins receiving a selected stream, the system accumulates received packets in the buffer until the receive buffer contains some number of packets. In the present invention, the buffer level is nominally set to 20. The system then begins removing and displaying the received packets. Note that this process introduces some delay into the system—the delay equals the amount of time required to receive 20 packets.

When the received RF signal is adequate, the rate of packet loss and re-transmission is low. As long as this holds true, the receive buffer level stays nominally around the desired ‘full’ level, which in the present case is 20 buffered packets. The client's buffer stays near the ‘full’ level because the client's rate-of-display is well matched to the transmitter's rate-of-transmission.

When the user travels into an area where the RF signal is weak or absent, the effective network throughput decreases. This is due to the inevitable loss and re-transmission of some of the transmitted packets. Since the effective packet arrival rate decreases, while the client's packet display rate has remained constant, the buffer level begins to decrease. When the receive buffer is empty, the client video display unavoidably freezes.

The receive buffer level is thus a good indicator of the RF link performance. In the present invention, this buffer level is made visible to the user by means of a bar graph display 77 on the client's video screen 79. The bar graph stays nominally full as long as the RF link performance is adequate. When the user travels beyond the service range of the network, or enters a ‘dead zone’ in the system coverage, the bar graph display drops as the receive buffer is drawn down. The user is thus given adequate warning of loss-of-signal, and may move into a more favorable area before the signal is totally lost.

While certain features and embodiments have been described in detail herein, it will be understood that the invention includes all modifications and enhancements within the scope and spirit of the following claims.

What is claimed is:

1. A surveillance system having wireless, portable monitoring module for use in connection with a video/image surveillance system having a remote camera, comprising:
a. A remote camera for collecting and transmitting digital signals represent video/images in the range of the camera;
b. A hub for receiving the signals;
c. A transmitter associated with the hub for transmitting the signals via a wireless transmission system;
d. A portable monitoring station associated having a receiver associated therewith and adapted for receiving the signals transmitted by the transmitter for displaying the signals as a video/image display thereat.

2. The surveillance system of claim 1, further including a plurality of cameras associated with the wireless hub, each of said cameras transmitting a unique signal to the hub and wherein the portable monitoring station is adapted for selecting any of the unique signals.

3. The surveillance system of claim 1, wherein said camera is a multicast camera adapted for generating a plurality of distinctive signals and wherein the portable monitoring station is adapted for selecting among the plurality of distinctive signals.

4. The surveillance system of claim 3, wherein the plurality of signal generated by the camera includes a QSIF signal.

5. The surveillance system of claim 3, wherein the plurality of signals generated by the camera includes an SIF signal.

6. The surveillance system of claim 3, wherein the plurality of signals generated by the camera include a JPEG or Wavelet signal.

7. The surveillance system of claim 3, wherein the plurality of signals generated by the camera include a wavelet signal.

8. The surveillance system of claim 1, further including a server associated with the hub.

9. The surveillance system of claim 8, wherein the server is adapted for archiving the signals.

10. The surveillance system of claim 9, wherein the portable module further includes a transmitter and the hub includes a receiver, whereby control signals may be sent to the server from the portable module and whereby archived signals may be sent from the server to the portable module.

11. The surveillance system of claim 10, wherein the transmitter and is an 802.11 type.

12. The surveillance system of claim 10, wherein the transmitter and receiver is a wireless IP type.

13. The surveillance system of claim 9, wherein the control signals sent by the portable module include camera control signals for controlling the camera.

14. The surveillance system of claim 13, wherein the camera control signals include a pan, tilt and zoom controls.

15. The surveillance system of claim 13, wherein the camera control signals include a brightness control.

16. The surveillance system of claim 13, wherein the camera control signals include a contrast control.

17. The surveillance system of claim 13, wherein the camera control signals include a focus control.

18. The surveillance system of claim 13, wherein the camera control signals include a hue control.

19. The surveillance system of claim 13 where the remote module is adapted for controlling the positioning of and focus of the camera during initial installation.

20. The surveillance system of claim 13, wherein the camera control signals include a encoder configuration controls.

21. The surveillance system of claim 1, further including a plurality of hubs associated with the camera, each hub having a transmitting zone in which the portable module will operate.

22. The surveillance system of claim 21, wherein the hubs are switched hubs.

23. The surveillance system of claim 1, wherein the camera is a multicast device and wherein there is included a unicast convertor associated with the hub for selecting and transmitting one of the selected multicast signals to the portable unit.

24. The surveillance system of claim 1, wherein the portable unit includes a buffer memory for receiving the transmitted signal and a video decoder for decompressing and decoding the transmitted signal in the buffer memory.

25. The surveillance system of claim 24, wherein the flow of information through the buffer memory is utilized to indicate signal strength of the signal transmitted from the hub to the portable module.

26. The surveillance system of claim 25, wherein the level of information in the buffer memory at any point in time indicates the strength of the signal being transmitted to the portable module on a real-time basis.

27. The surveillance system of claim 25, further including a visual indicator of signal strength at the portable module.

28. The surveillance system of claim 1, further including ancillary components in communication with the hub and the portable module.

29. The surveillance system of claim 28, wherein said ancillary components include a barcode reader on the portable module for transmitting barcode information to the server.

30. The surveillance system of claim 28, wherein said ancillary components include a magnetic strip reader on the portable module for transmitting magnetically stored information to the server.

31. The surveillance system of claim 7, wherein the portable module includes an access control signal generator for transmitting an access control signal to the server.

32. The surveillance system of claim 7, the portable module further including a camera for transmitting video/still image signals to the hub.

33. The surveillance system of claim 32, the camera also being adapted for transmitting the video/still image signals to an archival database.

34. The surveillance system of claim 32, further including additional monitoring stations and wherein the system is adapted for simultaneous viewing of the video/still image signals at said additional monitoring stations.

35. The surveillance system of claim 7, further including a notification signal generator associated with the portable module for sending a notification signal to the server.

36. The surveillance system of claim 35, wherein the notification signal includes any combination of the following notification message types:
a. Security Assist Request;
b. Medical Assist Request;
c. Fire Assist Request;
d. Intercom Request;
e. Video Intercom.

37. The surveillance system of claim 35, wherein the notification signal includes placing call to a common pager, including a description of an event.

38. The surveillance system of claim 35, wherein the notification signal includes placing a call to a designated telephone number and describing the event with a recorder.

39. The surveillance system of claim 35, wherein the notificiation signal includes placing a call to a designated telephone number and describing the event with a synthesized voice.

40. The surveillance system of claim 35, wherein the notification signal includes sending an email message to designated recipients.

41. The surveillance system of claim 35, wherein the notification signal includes generating a pop-up signal on an operator console.
